(19) United States
(12) Patent Application Publication
(10) Pub. No.: US 2005/0115941 A1
(43) Pub. Date: Jun. 2, 2005

(54) Laser containment structure allowing the use of plastics

(76) Inventors: Yefim P. Sukhman, Scottsdale, AZ (US); Christian J. Risser, Scottsdale, AZ (US); Edwin W. Gorham, Phoenix, AZ (US); Stefano J. Noto, Mesa, AZ (US); Cory W. Worth, Phoenix, AZ (US); David J. Aitchison, Gilbert, AZ (US)

Correspondence Address: ABELMAN, FRAYNE & SCHWAB, 150 EAST 42ND STREET, NEW YORK, NY, 10017-5612, US

(21) Appl. No.: 11/006,390

(22) Filed: Dec. 7, 2004

Related U.S. Application Data
(63) Continuation-in-part of application No. 10/210,121, filed on Jul. 31, 2002, now abandoned.

(51) Int. Cl. B23K 26/12

(52) U.S. Cl. 219/121.86

(57) ABSTRACT

A laser safety enclosure structure has an outer enclosure made of a formable material with a limited ability to withstand exposure to a laser beam and an inner enclosure composed of a laser beam blocking material capable of indefinitely withstanding exposure to a laser beam of a given wavelength and power level so as to prevent such a laser beam incident on the blocking material from escaping the inner enclosure.

### CROSS-REFERENCE TO RELATED APPLICATIONS

This application is a continuation-in-part of co-pending U.S. application Ser. No. 10/210,121, filed on Jul. 31, 2002; and of co-pending U.S. application Ser. No. 29/186,395, filed on Jul. 14, 2003, the disclosures of both applications being incorporated herein by reference in their respective entireties.

### BACKGROUND OF THE INVENTION

1. Field of the Invention

This invention relates to laser material processing systems, and in particular to a laser enclosure for safely containing the laser light used in such laser material processing systems.

2. Description of the Related Art

Material processing systems using high power lasers must be housed in enclosures which contain the laser beam and prevent human exposure to laser radiation in excess of safe limits. This is not only good design practice, but is also required by both federal and state regulations as overseen by the Center for Devices and Radiological Health (CDRH), a division of the Food and Drug Administration (FDA). According to federal regulations, in particular, 21 C.F.R. § 1040.10(f)(1), entitled PERFORMANCE REQUIREMENTS—(1) PROTECTIVE HOUSING: “Each laser product shall have a protective housing that prevents human access during operation to laser and collateral radiation that exceed the limits of Class I and table VI, respectively, wherever and whenever such human access is not necessary for the product to perform its intended function.”

To provide a Class I enclosure, the materials employed in the housing must be able to withstand indefinitely direct exposure to the beam of the laser in use in the system.

Common practice is to use sheet metal as the housing material to meet these requirements. However, sheet metal has the following drawbacks:
1. sheet metal manufacturing methods may be relatively expensive, especially for mass production;
2. low volume sheet metal manufacturing methods do not allow a wide range of shapes for the enclosures, which limits options for design aesthetics; and
3. stamping methods for sheet metal allow a wider range of shapes, but require expensive up-front tooling costs and are usually reserved for high volume manufacturing.

Plastics solve many of these problems, reducing material, tooling, and manufacturing costs and allowing a much wider range of shapes. However, plastics do not meet safety guidelines because they cannot contain a beam indefinitely in the case of direct exposure to the laser beam.

An exception to the requirement of indefinite containment is the use of visibly transparent plastics as view ports, as long as the plastics are not permeable to the laser wavelength in use. This is allowable if the material is capable of preventing the laser beam from penetrating through for a reasonable period of time, and so to allow the operator to recognize a problem and to turn off the equipment while at the same time, by nature of its transparency to visible light, providing the operator with a visual cue that a problem is occurring.

An example of this is the use of acrylic plastic as a view port for systems employing CO₂ lasers operating at 10.6 microns. The acrylic does not transmit this laser wavelength, but is transparent to visible light, allowing the operator to see whether the laser beam is striking the view port, or whether some other problem is occurring, before the beam burns through the view port, allowing the operator time to turn off the equipment before the enclosure is compromised.

Accordingly, manufacturers of laser material processing systems have conventionally used sheet metal enclosures to contain the laser beam and have employed clear glass or plastic only as viewing ports. As a result, since such systems are not usually built in large quantities, their enclosures have generally been restricted to square, boxy shapes.

### BRIEF SUMMARY OF THE INVENTION

It is therefore an object of the present invention to provide a laser enclosure for a laser material processing system that avoids the above-described difficulties of the prior art.

It is a further object of the present invention to provide a laser enclosure for a laser material processing system that provides the required degree of safety while at the same time is able to be manufactured in any desired shape at a reasonable cost.

The above and other objects are achieved by the present invention which, in one embodiment, is directed to a laser safety enclosure structure with a composite structure, having an outer enclosure having an interior surface, with the outer enclosure being made of a formable material with a limited ability to withstand exposure to a laser beam, and an inner enclosure covering substantially all of the interior surface and defining an interior volume for containing a laser beam, with the inner enclosure being composed of at least one layer of a laser beam blocking material capable of indefinitely withstanding exposure to a laser beam of a given wavelength and power level so as to prevent such a laser beam incident on the laser blocking material from escaping the inner enclosure.

In a preferred embodiment, the formable material is plastic and the laser blocking material is metal.

In the present invention, the laser safety enclosure includes a rigid outer enclosure having an interior surface, the outer enclosure being made of a formable material that becomes rigid after forming with a limited ability to withstand exposure to a laser beam; and an inner laser containment structure covering substantially all of the interior surface and defining an interior volume for containing a laser beam, the inner laser containment structure being composed of at least one layer of a laser beam blocking material capable of indefinitely withstanding exposure to a laser beam of a given wavelength and power level, the laser beam blocking capability being sufficient to prevent such a laser beam incident on the laser beam blocking material from escaping the inner laser containment structure.

The laser safety enclosure may have the inner laser containment structure including a first layer of laser beam blocking material connected to the interior surface. The first layer of laser beam blocking material may be laminated on the inner surface. The first layer of laser beam blocking material may also be connected to the interior surface using an adhesive. The first layer of laser beam blocking material may also be connected to the interior surface using at least one mechanical fastener.

The inner laser containment structure may also include a second layer of a formable material that becomes rigid after forming with a limited ability to withstand exposure to a laser beam, the first layer being sandwiched between the second layer and the interior surface of the outer enclosure. The first layer of the at least one layer of laser beam blocking material may be metal. The layer of formable material may be a plastic.

The present invention also includes a method of making a laser safety enclosure, comprising the steps of forming a rigid outer enclosure of a formable material that becomes rigid after forming with limited ability to withstand exposure to a laser beam, the outer enclosure having an interior surface; and making an inner laser containment structure of at least one layer of laser beam blocking material covering substantially all of the interior surface and defining an interior volume for containing a laser beam, the inner laser containment structure being composed of a material capable of withstanding indefinite exposure to a beam of a given wavelength and power level, the laser beam blocking capability being sufficient to prevent such a laser beam from escaping the inner laser containment structure.

The outer enclosure and the inner containment structure are made by the steps of: providing a sheet of formable material that becomes rigid after forming which presents a first surface that will become the interior surface of the outer enclosure; applying a first layer of laser beam blocking material to the first surface to form a laminate; and drawing the laminate into a predetermined shape to constitute the outer enclosure and the inner containment structure.

The applying step includes the step of attaching the laser beam blocking material to the first surface using an adhesive. In the method, the at least one layer of laser beam blocking material includes metal. Also in the method, the layer of formable material includes plastic. At least one of the step of forming the inner laser containment structure and the step of forming the outer enclosure employs a technique selected from the group of vacuum forming techniques, injection molding techniques, casting techniques and stamping techniques.

The step of forming the outer enclosure initially forms the outer enclosure as a separate entity, and the step of making the inner laser containment structure includes the step of attaching the laser beam blocking material to the interior surface of the formed outer enclosure to form the inner laser containment structure.

The step of making the outer enclosure initially forms the inner laser containment structure as a separate entity, and the attaching step includes the step of connecting the made inner laser containment structure to the interior surface of the formed outer enclosure.

In the method, the inner laser containment structure is made by stamping the laser beam blocking material. Also in the method, the attaching step includes the step of applying the laser beam blocking material to the interior surface as a powder. The powder may include a metal and is attached to the interior surface by an application technique selected from the group of spraying and sintering.

The present invention also includes a laser safety enclosure, which includes a rigid laser containment structure made from a plurality of walls and defining an interior volume for containing a laser beam, each of the walls being formed from: a mixture of a moldable material; and a laser beam blocking material in an amount sufficient to make the walls capable of withstanding indefinite exposure to a laser beam of a given wavelength and power level, the laser beam blocking capability being sufficient to prevent such a laser beam from escaping the laser containment structure. In this laser safety enclosure, the moldable material may be a plastic resin. The laser beam blocking material may be a metal powder.

The present invention also includes a method of making a laser safety enclosure, having the steps of: making a mixture of moldable material and an amount of laser beam blocking material sufficient to make a wall formed of the mixture capable of withstanding indefinite exposure to a laser beam of a given wavelength and power level, the laser beam blocking capability being sufficient to prevent such a laser beam from escaping through the wall; and making a laser containment structure having a wall formed of the mixture. In the method, the moldable material includes a plastic resin. Also in the method, the laser beam blocking material may be a metal powder.

The present invention also includes a laser safety enclosure for containing a material object for laser processing thereof, and includes an outer containment structure having an interior surface, the outer containment structure being made of a formable material and including a base member having an upstanding wall which defines an enclosed space for supporting the material object thereon to be processed by a laser beam; and an inner containment structure covering substantially all of the interior surface and defining an interior volume for containment of the laser beam, the inner containment structure being composed of at least one layer of a laser beam blocking material capable of indefinitely withstanding exposure to a laser beam of a predetermined wavelength and power level, the laser beam blocking capability being sufficient to prevent the laser beam incident thereupon from escaping the inner containment structure.

The present invention also includes a method of making a laser safety enclosure for containing a material object for laser processing thereof, with the steps of: forming an outer containment structure of a formable material and including a base member having an upstanding wall which defines an enclosed space for supporting the material object thereon to be processed by a laser beam, the outer containment structure having an interior surface; and making an inner containment structure of at least one layer of laser beam blocking material covering substantially all of the interior surface and defining an interior volume for containment of a laser beam, the inner containment structure being composed of a material capable of withstanding indefinite exposure to a laser beam of a predetermined wavelength and power level, the laser beam blocking capability material being sufficient to prevent the laser beam incident thereupon from escaping the inner containment structure.

The present invention also includes a laser safety enclosure for containing a material object for laser processing thereof, having a containment structure made from a base member having an upstanding wall which defines an enclosed space for supporting the material object thereon to be processed by a laser beam, and defining an interior volume for containment of a laser beam, each of the base and upstanding wall being formed from a mixture of a moldable material and a laser beam blocking material in an amount sufficient to make the base and upstanding wall capable of withstanding indefinite exposure to a laser beam of a predetermined wavelength and power level, the laser beam blocking material capability being sufficient to prevent the laser beam incident thereupon from escaping the containment structure.

The present invention also includes a method of making a laser safety enclosure for containing a material object for laser processing thereof, having the steps of: making a mixture of moldable material and an amount of laser beam blocking material sufficient to make a base member having an upstanding wall formed of the mixture capable of withstanding indefinite exposure to a laser beam of a predetermined wavelength and power level, the laser beam blocking capability being sufficient to prevent the laser beam incident thereupon from escaping through the base member or the upstanding wall; and making a containment structure having the base member including the upstanding wall formed of the mixture.

The present invention also includes a laser safety enclosure structure with composite structure, having an outer enclosure having an interior surface, the outer enclosure being made of a formable material and including a base member having an upstanding wall which defines an enclosed space for supporting the material object thereon to be processed by a laser beam; and an inner enclosure covering substantially all of the interior surface and defining an interior volume for containing a laser beam, the inner enclosure being composed of at least one layer of a laser beam blocking material, including a first layer, capable of indefinitely withstanding exposure to a laser beam of a predetermined wavelength and power level, the laser beam blocking capability being sufficient to prevent the laser beam incident thereupon from escaping the inner enclosure; and wherein at least the first layer of laser beam blocking material is connected to the interior surface using at least one mechanical fastener.

These and other objects, features, and advantages of the present invention will be apparent from the following detailed description of the preferred embodiments taken in conjunction with the following drawings, wherein like reference numerals denote like elements.

### BRIEF DESCRIPTION OF THE SEVERAL VIEWS OF THE DRAWINGS

Preferred embodiments of the invention are disclosed hereinbelow with reference to the drawings, wherein:

FIG. 1 is a top front left side perspective view of a laser cabinet incorporating a laser safety enclosure of the present invention;

FIG. 2 is a side cross-sectional view of the laser safety enclosure along lines 2-2 in FIG. 1 in accordance with a first preferred embodiment of the present invention;

FIG. 3 is a side cross-sectional view of the laser safety enclosure along lines 2-2 in FIG. 1 in accordance with a second preferred embodiment of the present invention;

FIG. 4 is a side cross-sectional view of the laser safety enclosure along lines 2-2 in FIG. 1 in accordance with a third preferred embodiment of the present invention;

FIG. 5 is a side cross-sectional view of the laser safety enclosure along lines 2-2 in FIG. 1 in accordance with a fourth preferred embodiment of the present invention;

FIG. 6 is a side cross-sectional view of the laser safety enclosure along lines 2-2 in FIG. 1 in accordance with a fifth preferred embodiment of the present invention;

FIG. 7 is a side cross-sectional view of the laser safety enclosure along lines 2-2 in FIG. 1 in accordance with a sixth preferred embodiment of the present invention; and

FIG. 8 is a side cross-sectional view of an alternative embodiment of the laser safety enclosure in accordance with a seventh preferred embodiment of the present invention.

### DETAILED DESCRIPTION OF THE INVENTION

The present invention is generally directed to a composite structure for a laser safety enclosure in which the exterior material of an outer enclosure is selected for low cost and ease of manufacturing and the ability to be formed into more complex, curved, homogeneous shapes with greater aesthetic appeal and without regard to the ability of the exterior material to block and contain the laser beam. As used in the present application, a material having this ability to be formed into such shapes is termed a formable material, a primary example being plastic.

The use of this exterior material is combined with the use of an interior material to make an inner enclosure forming an inner laser containment structure having laser beam blocking capability, with the inner material being selected for its ability to block and contain the laser beam. A primary example of a suitable inner material is metal.

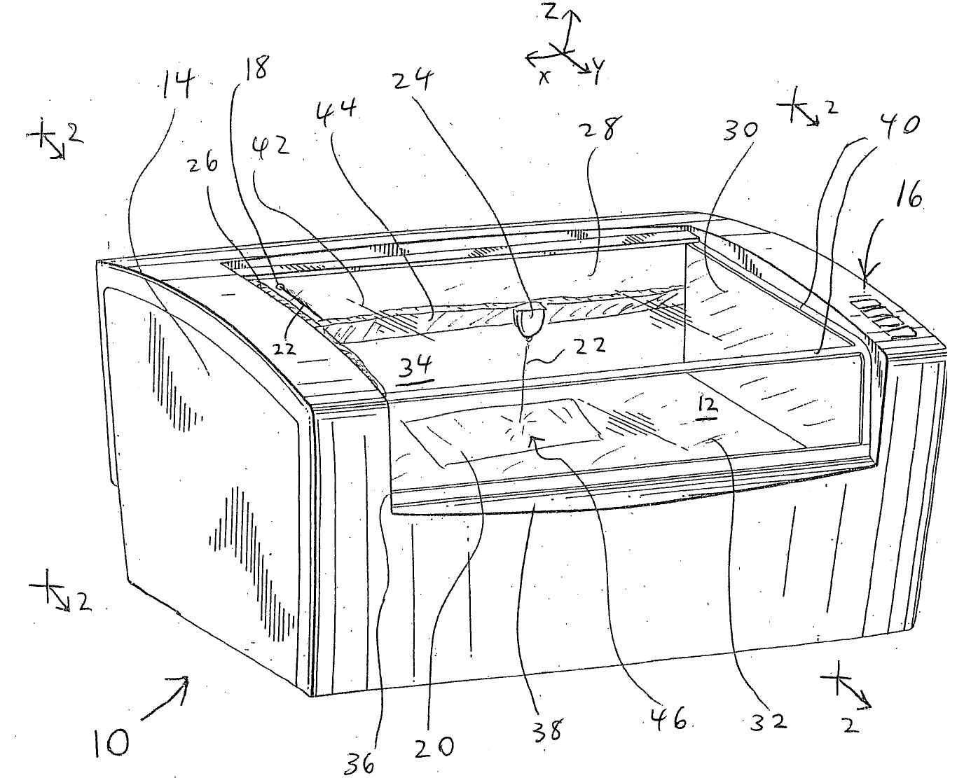

As shown in FIG. 1, a laser cabinet 10 is illustrated in a top front left side perspective view, with the laser cabinet 10 incorporating a laser safety enclosure 12 of the present invention. The laser cabinet 10 includes an outer housing 14 in which is mounted the laser safety enclosure 12. A control device 16 such as a plurality of operating buttons may extend through apertures in the outer housing 14, and at least one vent may be provided for the exhaust of heat from the laser cabinet 10 during the laser operations. The laser cabinet 10 and the laser safety enclosure 12 are dimensioned to receive therein a workpiece 20 to be etched, engraved, and/or cut by a laser beam 22 from a laser device, for example, positioned behind the wall 28. The laser beam 22 is directed from the laser device through an aperture 18 in, for example, the wall 28 to be incident upon optics, such as mirrors and/or lenses, mounted on and/or within the moveable arm 44 which direct the laser beam 22 to optics, such as mirrors and/or lenses including a focusing lens, on and/or within a moveable carriage 24 which finally direct the laser beam 22 downward onto the workpiece 20. As described herein, the moveable arm 44 moves in any direction parallel to the Y-axis within the laser safety enclosure 12, and the moveable carriage 24 moves along the movable arm 44 in any direction parallel to the X-axis within the laser safety enclosure to direct the laser beam 22 onto any location in the X-Y plane, such as any predetermined position on the workpiece 20 to be etched, engraved, and/or cut by the laser beam 22.

The laser safety enclosure 12 includes a plurality of upstanding walls and wall portions, such as the upstanding walls 26, 28, 30 extending upward from a base member 32, with the upstanding walls 26-30 and the base member 32 being wall portions fabricated from materials described herein to be substantially rigid; that is, retaining a single firm and stiff configuration after initial fabrication. The upstanding walls 26-30 and base member 32 define an interior space 34 therein for receiving the workpiece 20 which is etched, engraved, or cut by the laser beam 22.

By having such upstanding walls 26-30 and the base member 32 capable of substantially and/or completely blocking any laser beams 22 or reflections therefrom originating within the laser safety enclosure 12 as the workpiece 20 is etched, engraved, or cut, any laser beams 22 which pass through the workpiece 20 or which otherwise do not contact the workpiece 20 are blocked by the upstanding walls 26-30 and the base member 32 and thus are prevented from exiting the laser safety enclosure 12 and the laser cabinet 10. Therefore, both the control electronics of the laser cabinet 10 and the user of the laser cabinet 10 are protected from damage during the laser operations of the laser cabinet 10.

The interior space 34 of the laser safety enclosure 12 is accessible through an opening 36 in the outer housing 14, which may be removably covered by a hinged or removable door 38. The door 38 may include a frame 40 for retaining glass or other materials forming at least one window 42 which may be transparent or opaque. In a preferred embodiment, the frame 40 retains plastic panes which are opaque to the wavelength of the laser beam 22, but which may be transparent to other wavelengths of light, such as visible light to allow the operator to monitor the laser operations. In additional embodiments, the walls 26-30 and the base member 32 as well as additional laser blocking walls and/or panels wrap around the top on the right and left of the at least one window 42, such that the window 42 slightly overlaps the laser safety enclosure 12 so that unintentional reflections of the laser beam 22 inside the laser safety enclosure 12 cannot escape the enclosure 12.

Accordingly, by opening or removing the door 38, a user may place the workpiece 20 on the base member 32 in any orientation in the interior space 34 for the workpiece 20 to be worked on by the laser beam 22. The workpiece 20 may then be removed from the interior space 34 through the door 38 after the laser operations are completed.

The moveable carriage 24 is mounted on a motion device, such as at least one movable arm 44, for maneuvering the laser beam 22 in any selected direction in the X-Y plane, such as a programmed path of travel in order to selectively direct the laser beam 22 from the laser device behind the wall 28 to be incident at any desired target locations 46 on the workpiece 20.

The laser device, the moveable carriage 24, the motion device with the at least one moveable arm 44, and other components of the laser cabinet 10 are described in commonly assigned U.S. Pat. Nos. 5,661,746; 5,754,575; 5,867,517; 5,881,087; 5,894,493; 5,901,167; 5,982,803; 6,181,719;6,313,433; 6,342,687; 6,423,925; and 6,424,670, each of which is incorporated herein by reference in their respective entireties.

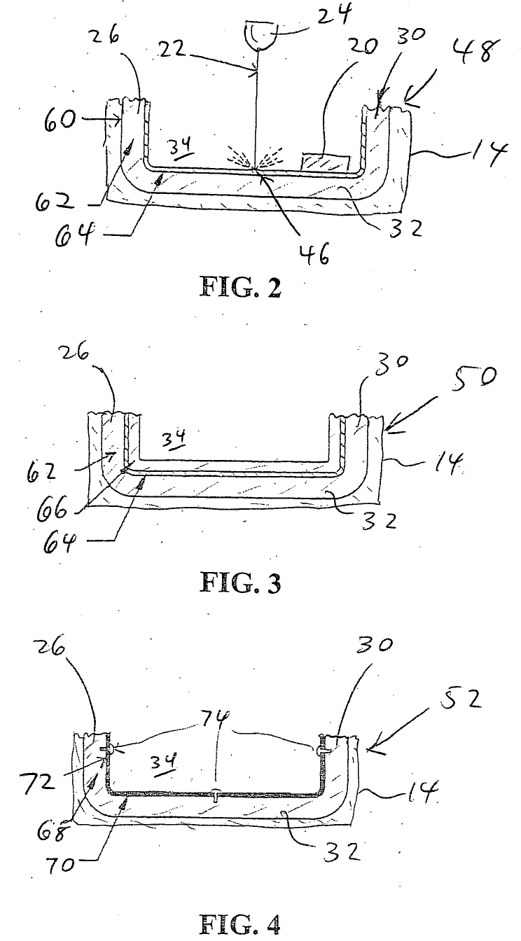

The present invention is directed to the laser safety enclosure 12, with various embodiments 48-58 shown in FIGS. 2-7, respectively. Generally, the laser safety enclosure 12, in its various embodiments, includes an inner laser containment structure and an optional outer structure in which the inner laser containment structure is placed. The inner laser containment structure includes a laser beam blocking material such as metal or other known substances having laser beam blocking capacity; that is, the inner laser containment structure is capable of blocking laser beams from passing therethrough.

FIG. 2 is a side cross-sectional view of a first embodiment of the present invention, with at least one rigid wall portion 60 shaped to form the laser safety enclosure 48 with the upstanding walls 26, 30 and the base member 32 of the laser safety enclosure 48, with the cross-sectional view taken along lines 2-2 in FIG. 1 in accordance with the present invention. It will be understood that substantially all of the wall portions forming the upstanding walls 26-30 and the base member 32 of the laser safety enclosure 48 have the disclosed composite structure of the wall portion 60, with the possible exception of a viewing port or window 42 constructed in accordance with conventional techniques.

As shown in FIG. 2, the wall portion 60 includes a first layer 62 of a suitable exterior material as defined above and forming an outer enclosure. The wall portion 60 also includes a second layer 64 of a suitable interior material as defined above and forming an inner laser containment structure. In accordance with a preferred embodiment of the present invention, the first layer 62 is plastic and the second layer 64 is metal, for example, aluminum. The wall portion 60, and the rest of the laser safety enclosure 48, including of the first layer 62 and the second layer 64, are created, for example, by applying a thin foil of aluminum to the inside of a sheet of plastic material using adhesive and then drawing the plastic and foil laminate into the appropriate shape using any suitable technique, for example, by vacuum forming techniques.

The foil must be of an appropriate thickness both to provide sufficient mechanical strength against tearing during the forming process and over the life of the enclosure 48, and to contain indefinitely the laser beam 22 of the intended wavelength and power level in order to meet the safety requirements. Experimental trials have indicated that the ranges of about 0.010 inches (0.0254 cm.) to about 0.015 inches (0.0381 cm.) thick for aluminum and about 0.005 inches (0.0127 cm.) to about 0.010 inches (0.0254 cm.) thick for copper meet both goals for unfocused CO₂ laser beams with power levels under about 150 watts. It will be understood that an appropriate thickness of a suitable interior material appropriate for any specified laser wavelength and power level may be determined by one of ordinary skill in the art in accordance with the teachings of this specification.

Referring again to FIG. 1, when a viewing port or window 42 is provided for viewing the interior space 34 or volume from the outside of any of the various embodiments of the laser safety enclosure described herein, the laser blocking material is absent from the window 42.

Other methods of constructing the wall portion 60 of the laser safety enclosure 48 in FIG. 2 are contemplated to be within the scope of the present invention. For example, in the embodiment of the laser safety enclosure 50 shown in FIG. 3, a third layer 66 of plastic may be used, with the second layer 64 of metal between the first layer 62 and the third layer 66. In this embodiment, the first layer 62 is the outer enclosure, and the combination of the second layer 64 and the third layer 66 is the inner laser containment structure.

To create this structure, the foil may be laminated between two sheets of plastic and then formed into the appropriate shape using, for example, vacuum forming techniques. This provides an extra layer of protection for the foil to guard against ripping or tearing over the life of the laser safety enclosure 50. It also may improve the aesthetic appearance of the inside of the laser cabinet 10.

In another preferred embodiment of the laser safety enclosure 52 shown in FIG. 4, a plastic layer 68 is the outer enclosure, and a metal layer 70 is the inner laser containment structure. The metal layer 70 may be made separately, for example by using the same type of vacuum forming technique employed for the plastic and metal laminate of the first and second embodiments or by stamping or other methods if quantities permit. This allows the metal layer 70, for example, aluminum foil, to be made in the appropriate shape to mate to the interior surface 72 of an injection molded or cast housing, such as plastic layer 68 forming the outer enclosure. The metal layer 70 may be attached to the interior surface 72 of the plastic layer 68 using an adhesive between the layers 68, 70 or using any known type of mechanical fasteners 74, as shown in FIG. 4.

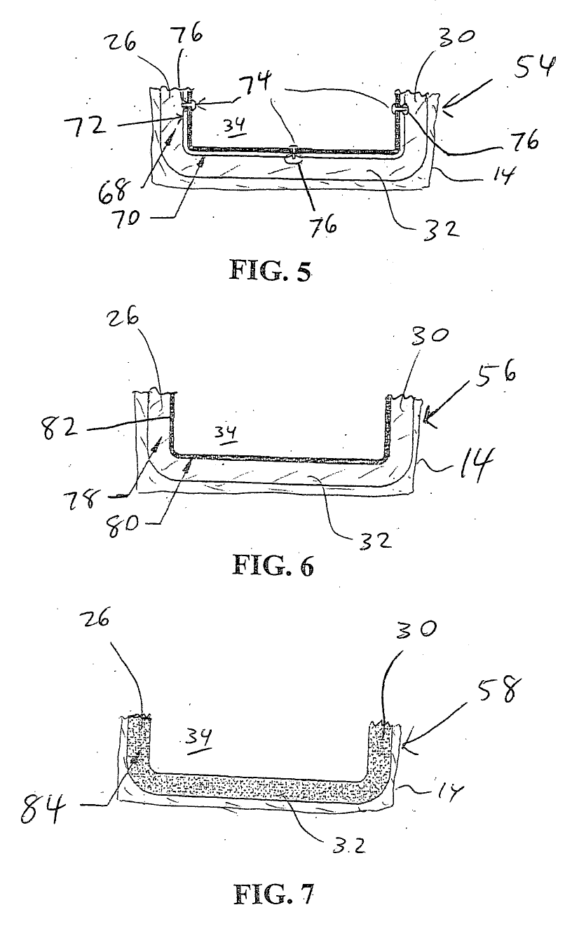

Alternatively, as shown in FIG. 5, in another embodiment, the laser safety enclosure 54 has a plastic layer 68 as the outer enclosure, and a metal layer 70 as the inner laser containment structure, with the metal layer 70 spaced from the interior surface 72 of the plastic layer 68, and with the mechanical fasteners 74 being attached to bosses 76 on the interior surface 72 of the plastic layer 68.

In another preferred embodiment of the laser safety enclosure 56 shown in FIG. 6, a plastic housing 78 forms the outer enclosure and a metal layer 80 forms the inner laser containment structure, with the metal layer 80 including laser blocking material which may be applied in the form of a metal powder that is sprayed or sintered to the interior surface 82 of the plastic housing 78 to form the metal layer 80 attached thereto with a sufficient thickness for laser beam confinement.

In yet another preferred embodiment of the laser safety enclosure 58 shown in FIG. 7, the inner laser containment structure 84 of the laser safety enclosure 58 includes metal powder which may be mixed into a plastic resin to create a formable composite material having the appropriate heat dissipation and laser beam containment characteristics. An outer enclosure of plastic or other materials for retaining the inner laser containment structure 84 may be optionally provided. The composite material may thereafter be formed into the wall portions forming the upstanding walls 26, 30 and the base member 32 of the laser safety enclosure 58.

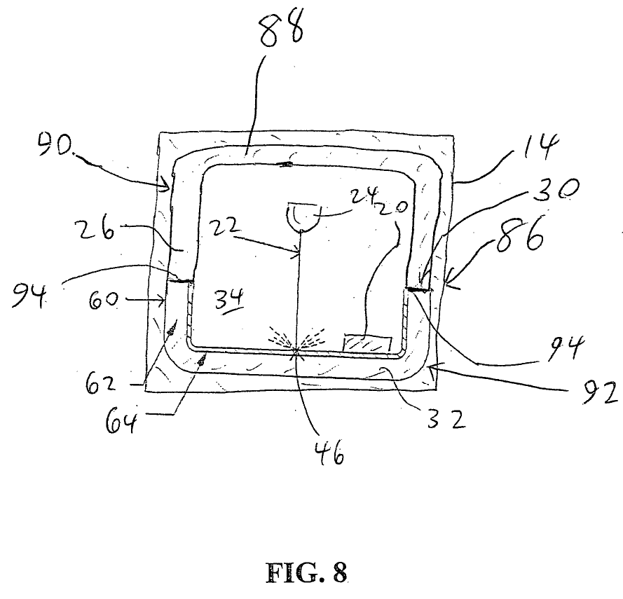

It is understood that the laser safety enclosure 12 of FIG. 1 and its various example embodiments 48-58 shown in FIGS. 1-8 may be configured, dimensioned, and oriented in any known manner within the outer housing 14, with or without the window 42 through the outer housing 14. For example, the laser safety enclosure 12 may form a completely enclosed box such as a sealed or sealable enclosure, as shown in an alternative embodiment in FIG. 8, which is lined with and/or which includes the laser blocking material for retaining the laser beam 22 therein.

In the alternative embodiment shown in FIG. 8 in a side cross-sectional view, a laser safety enclosure 86 is shown in accordance with a seventh preferred embodiment of the present invention, in which the interior space 34 is substantially completely enclosed and/or sealed in all three directions, with only the X-Z cross-sectional view being shown in FIG. 8. In a further alternative embodiment, the laser safety enclosure 86 may include at least one window and/or a door as described herein with respect to the embodiment shown in FIG. 1, allowing the user to insert and remove the workpiece 20 and allowing the user to view the operation of the laser beam 22 for cutting, engraving and/or etching the workpiece 20.

It is understood that some structures may optionally extend through the upstanding walls 26, 30 or the base member 32 of the substantially completely enclosed and/or sealed laser safety enclosure 86, such as control wires from a control device 16, such as shown in FIG. 1, to the moveable carriage 24 for causing the moveable carriage 24 and/or any motion system attached to the moveable carriage 24 to move and/or to be controlled during the laser operations of the laser device behind the wall 28 which generates the laser beam 22.

In the alternative embodiment shown in FIG. 8, the laser safety enclosure 86 may be a rigid monolithic unit without a window 42 or other apertures therethrough, with the laser safety enclosure 86 formed by the upstanding walls 26, 30 and base member 32 as well as an upper wall portion 88. Such wall portions forming the upstanding walls 26, 30, the base member 32, and the upper wall portion 88 may include combinations and/or compositions of materials, such as rigid outer enclosures and inner laser containment structures, formed from the layers combined to form the wall portions as described herein in connection with the first embodiment of the laser safety enclosure 48 of FIG. 2.

It is understood that the rigid upstanding walls 26, 30, the base member 32, and the upper wall portion 88 may alternatively include such combinations and/or compositions of materials shown and described in the various embodiments 50-58 in FIGS. 3-7.

Optionally, the laser safety enclosure 86 of FIG. 8 may include an integrated unit from the juxtaposition of a top member 90 and a bottom member 92 forming, for example, approximate halves of the laser safety enclosure 86, with a substantially closed seam 94 between the juxtaposed top member 90 and bottom member 92. Accordingly, the members 90, 92 may be separated to insert the workpiece 20 into the interior space 34, and the members 90, 92 may then be juxtaposed together as shown in FIG. 8 during laser operations by the laser device creating the laser beam 22. In an example embodiment, the members 90, 92 may be connected together by a hinge to open and close the substantially sealed laser safety enclosure 86. For example, the top member 90 may be attached to the door 38 in FIG. 1 to swing away from the bottom member 92 for inserting the workpiece 20 into the interior space 34.

The laser safety enclosure 12 and its various example embodiments 48-58 and 86 shown in FIGS. 1-8, respectively, and constructed in accordance with the present invention, provide many advantages over the enclosures of the prior art. The invention allows the use of a wide range of plastic fabrication methods such as injection molding, casting and vacuum forming, which may provide significant cost savings over sheet metal techniques at various quantity levels.

The invention may also take advantage of relatively inexpensive materials, such as acrylic, polycarbonate, urethane, and acrylonitrile-butachene-styrene (ABS) for the exterior material, and aluminum or copper for the interior material.

In addition, the invention allows for a much wider range of shapes for the enclosure of the laser product than does standard bending and welding of sheet metal, thus allowing for an improvement in aesthetics, functionality, and overall product appeal to the consumer.

Use of the present invention also means that the tooling costs for complex shapes are significantly less than those for stamping sheet metal, and plastic fabrication is much more suited to mass production than standard bending and welding of sheet metal.

While the preferred embodiment of the present invention has been shown and described herein, it will be obvious that such embodiment is provided by way of example only. Numerous variations, changes and substitutions will occur to those skilled in the art without departing from the invention herein. Accordingly, it is intended that the invention be limited only by the spirit and scope of the appended claims.

1. A laser safety enclosure which comprises:
a rigid outer enclosure having an interior surface, said outer enclosure being made of a formable material that becomes rigid after forming with a limited ability to withstand exposure to a laser beam; and
an inner laser containment structure covering substantially all of said interior surface and defining an interior volume for containing a laser beam, said inner laser containment structure being composed of at least one layer of a laser beam blocking material capable of indefinitely withstanding exposure to a laser beam of a given wavelength and power level, the laser beam blocking capability being sufficient to prevent such a laser beam incident on said laser beam blocking material from escaping said inner laser containment structure.

2. The laser safety enclosure of claim 1, wherein said inner laser containment structure comprises a first layer of laser beam blocking material connected to said interior surface.

3. The laser safety enclosure of claim 2, wherein said first layer of laser beam blocking material is laminated on said inner surface.

4. The laser safety enclosure of claim 2, wherein said first layer of laser beam blocking material is connected to said interior surface using an adhesive.

5. The laser safety enclosure of claim 2, wherein said first layer of laser beam blocking material is connected to said interior surface using at least one mechanical fastener.

6. The laser safety enclosure of claim 2, said inner laser containment structure further including a second layer of a formable material that becomes rigid after forming with a limited ability to withstand exposure to a laser beam, said first layer being sandwiched between said second layer and said interior surface of said outer enclosure.

7. The laser safety enclosure of claim 1, wherein a first layer of said at least one layer of laser beam blocking material is metal.

8. The laser safety enclosure of claim 1, wherein said layer of formable material is a plastic.

9. A method of making a laser safety enclosure, comprising the steps of:
forming a rigid outer enclosure of a formable material that becomes rigid after forming with limited ability to withstand exposure to a laser beam, the outer enclosure having an interior surface; and
making an inner laser containment structure of at least one layer of laser beam blocking material covering substantially all of the interior surface and defining an interior volume for containing a laser beam, the inner laser containment structure being composed of a material capable of withstanding indefinite exposure to a beam of a given wavelength and power level, the laser beam blocking capability being sufficient to prevent such a laser beam from escaping the inner laser containment structure.

10. The method of claim 9, wherein the outer enclosure and the inner containment structure are made by the steps of:
providing a sheet of formable material that becomes rigid after forming which presents a first surface that will become the interior surface of the outer enclosure;
applying a first layer of laser beam blocking material to the first surface to form a laminate; and
drawing the laminate into a predetermined shape to constitute the outer enclosure and the inner containment structure.

11. The method of claim 10, wherein said applying step includes the step of attaching the laser beam blocking material to the first surface using an adhesive.

12. The method of claim 9, wherein the at least one layer of laser beam blocking material includes metal.

13. The method of claim 9, wherein the layer of formable material includes plastic.

14. The method of claim 9, wherein at least one of said step of forming the inner laser containment structure and said step of forming the outer enclosure employs a technique selected from the group of vacuum forming techniques, injection molding techniques, casting techniques and stamping techniques.

15. The method of claim 9, wherein said step of forming the outer enclosure initially forms the outer enclosure as a separate entity, and said step of making the inner laser containment structure includes the step of attaching the laser beam blocking material to the interior surface of the formed outer enclosure to form the inner laser containment structure.

16. The method of claim 15, wherein said step of making the outer enclosure initially forms the inner laser containment structure as a separate entity, and said attaching step includes the step of connecting the made inner laser containment structure to the interior surface of the formed outer enclosure.

17. The method of claim 16, wherein the inner laser containment structure is made by stamping the laser beam blocking material.

18. The method of claim 15, wherein said attaching step includes the step of applying the laser beam blocking material to the interior surface as a powder.

19. The method of claim 18, wherein the powder includes a metal and is attached to the interior surface by an application technique selected from the group of spraying and sintering.

20. A laser safety enclosure, which comprises:
a rigid laser containment structure made from a plurality of walls and defining an interior volume for containing a laser beam, each of said walls being formed from:
a mixture of a moldable material; and
a laser beam blocking material in an amount sufficient to make said walls capable of withstanding indefinite exposure to a laser beam of a given wavelength and power level, the laser beam blocking capability being sufficient to prevent such a laser beam from escaping the laser containment structure.

21. The laser safety enclosure of claim 20, wherein the moldable material is a plastic resin.

22. The laser safety enclosure of claim 20, wherein the laser beam blocking material is a metal powder.

23. A method of making a laser safety enclosure, comprising the steps of:
making a mixture of moldable material and an amount of laser beam blocking material sufficient to make a wall formed of the mixture capable of withstanding indefinite exposure to a laser beam of a given wavelength and power level, the laser beam blocking capability being sufficient to prevent such a laser beam from escaping through the wall; and
making a laser containment structure having a wall formed of the mixture.

24. The method of claim 23, wherein the moldable material includes a plastic resin.

25. The method of claim 23, wherein the laser beam blocking material is a metal powder.

26. A laser safety enclosure for containing a material object for laser processing thereof, which comprises:
an outer containment structure having an interior surface, said outer containment structure being made of a formable material and including a base member having an upstanding wall which defines an enclosed space for supporting the material object thereon to be processed by a laser beam; and
an inner containment structure covering substantially all of said interior surface and defining an interior volume for containment of the laser beam, said inner containment structure being composed of at least one layer of a laser beam blocking material capable of indefinitely withstanding exposure to a laser beam of a predetermined wavelength and power level, the laser beam blocking capability being sufficient to prevent the laser beam incident thereupon from escaping said inner containment structure.

27. A method of making a laser safety enclosure for containing a material object for laser processing thereof, comprising the steps of:
forming an outer containment structure of a formable material and including a base member having an upstanding wall which defines an enclosed space for supporting the material object thereon to be processed by a laser beam, the outer containment structure having an interior surface; and
making an inner containment structure of at least one layer of laser beam blocking material covering substantially all of the interior surface and defining an interior volume for containment of a laser beam, the inner containment structure being composed of a material capable of withstanding indefinite exposure to a laser beam of a predetermined wavelength and power level, the laser beam blocking capability material being sufficient to prevent the laser beam incident thereupon from escaping the inner containment structure.

28. A laser safety enclosure for containing a material object for laser processing thereof, which comprises:
a containment structure made from a base member having an upstanding wall which defines an enclosed space for supporting the material object thereon to be processed by a laser beam, and defining an interior volume for containment of a laser beam, each of said base and upstanding wall being formed from a mixture of a moldable material and a laser beam blocking material in an amount sufficient to make said base and upstanding wall capable of withstanding indefinite exposure to a laser beam of a predetermined wavelength and power level, the laser beam blocking material capability being sufficient to prevent the laser beam incident thereupon from escaping the containment structure.

29. A method of making a laser safety enclosure for containing a material object for laser processing thereof, comprising the steps of:
making a mixture of moldable material and an amount of laser beam blocking material sufficient to make a base member having an upstanding wall formed of the mixture capable of withstanding indefinite exposure to a laser beam of a predetermined wavelength and power level, the laser beam blocking capability being sufficient to prevent the laser beam incident thereupon from escaping through the base member or the upstanding wall; and
making a containment structure having the base member including the upstanding wall formed of the mixture.

30. A laser safety enclosure structure with composite structure, which comprises:
an outer enclosure having an interior surface, said outer enclosure being made of a formable material and including a base member having an upstanding wall which defines an enclosed space for supporting the material object thereon to be processed by a laser beam; and
an inner enclosure covering substantially all of said interior surface and defining an interior volume for containing a laser beam, said inner enclosure being composed of at least one layer of a laser beam blocking material, including a first layer, capable of indefinitely withstanding exposure to a laser beam of a predetermined wavelength and power level, the laser beam blocking capability being sufficient to prevent the laser beam incident thereupon from escaping said inner enclosure; and
wherein at least the first layer of laser beam blocking material is connected to the interior surface using at least one mechanical fastener.
